(19) United States
(12) Patent Application Publication
(10) Pub. No.: US 2015/0089135 A1
(43) Pub. Date: Mar. 26, 2015

(54) INFORMATION PROCESSING SYSTEM AND METHOD FOR CONTROLLING DATA ACCESS TO STORAGE DEVICES

(71) Applicant: FUJITSU LIMITED, Kawasaki-shi (JP)

(72) Inventor: Ken Iizawa, Yokohama (JP)

(73) Assignee: FUJITSU LIMITED, Kawasaki-shi (JP)

(21) Appl. No.: 14/457,418

(22) Filed: Aug. 12, 2014

(30) Foreign Application Priority Data
Sep. 26, 2013 (JP) 2013-200002

(51) Int. Cl. G06F 3/06

(52) U.S. Cl. CPC G06F 3/0605; G06F 3/0689; G06F 3/0665; G06F 2003/0692
USPC 711/114

(57) ABSTRACT

An information processing system includes a plurality of storage devices and an information processing device. Each of the plurality of storage devices is configured to store therein both of block data and meta data. The information processing device includes a first processor. The first processor is configured to write first meta data to a first storage device from among the plurality of storage devices. The first processor is configured to write first block data corresponding to the first meta data to a second storage device from among the plurality of storage devices. The second storage device is different from the first storage device.

### CROSS-REFERENCE TO RELATED APPLICATION

This application is based upon and claims the benefit of priority of the prior Japanese Patent Application No. 2013-200002, filed on Sep. 26, 2013, the entire contents of which are incorporated herein by reference.

### FIELD

The embodiment discussed herein is related to an information processing system and a method for controlling data access to storage devices.

### BACKGROUND

In a storage system that includes a client and a server and accumulates streaming data (a long chain of chronological data), the client divides the streaming data into blocks (pieces of block data) and transmits a write request to the server in a unit of the block. The transmitted write request includes meta data and a block.

The server stores the meta data and the block in a storage device in response to the write request.

The client issues a search request and a read request for the meta data and the block that are written to the storage device by the server in response to the write request. The search request is issued to search the meta data stored in the storage device for identification (ID) information of the block. Based on the search result, the read request is issued to read the block. Thus, the read request is not issued without the preceding search request. When merely a part of blocks to be searched matches the search conditions, the accesses to the storage device by the server are mainly accesses for the meta data.

For example, as illustrated in FIG. 16, a technology is known by which a server writes meta data and a block to a plurality of storage devices 40.

In the example illustrated in FIG. 16, four storage devices 40 are provided.

Hereinafter, in a description that is made with reference to FIG. 16, when one of the plurality of storage devices 40 is specified, the storage devices are simply referred to as storage devices #1 to #4. In FIG. 16, a hatched portion in a storage device 40 indicates an area to which meta data and blocks have been already written.

In a traditional storage system, a server writes a block and meta data corresponding to the block in the plurality of storage devices 40 sequentially while causing the block and the meta data to be continuous. That is, first, the server writes a block and meta data to the storage device #1, writes a block and meta data to the storage device #2 when the storage device #1 runs out of space to write data, and then, writes a block and meta data to the storage device #3 when the storage device #2 runs out of space to write data. In the example illustrated in FIG. 16, it is indicated that writing has been completed to the storage device #1 and the storage device #2 and partially completed to the storage device #3, (see the hatched portions).

FIG. 16 illustrates a state in which the server writes a block to the storage device #3 (I1). However, the write performance may be reduced when read access occurs to the storage device #3 (I2) while the server is writing the block to the storage device #3. As a result, an execution time for the write request is extended, and discard of the write request may occur easily.

Therefore, for example, as illustrated in FIG. 17, a technology is known by which a server writes meta data and a block to different storage devices 40 respectively.

In the example illustrated in FIG. 17, five storage devices 40 are provided.

Hereinafter, in a description that is made with reference to FIG. 17, when one of the plurality of storage devices 40 is specified, the storage devices are simply referred to as storage devices #1 to #5. In FIG. 17, a hatched portion in a storage device 40 indicates an area to which meta data or blocks have been already written.

In the example illustrated in FIG. 17, the storage devices #1 to #4 are dedicated to blocks, and the storage device #5 is dedicated to meta data. That is, the server writes meta data to the storage device #5, and writes blocks to the plurality of storage devices #1 to #4 sequentially. That is, first, the server writes a block to the storage device #1, and writes the corresponding meta data to the storage device #5. The server writes a block to the storage device #2 when the storage device #1 runs out of space to write data, and writes the corresponding meta data in the storage device #5. The server writes a block to the storage device #3 when the storage device #2 runs out of space to write data, and writes the corresponding meta data to the storage device #5. In the example illustrated in FIG. 17, it is indicated that writing has been completed to the storage device #1 and the storage device #2, and partially completed to the storage device #3 and the storage device #5 (see the hatched portions).

FIG. 17 illustrates a state in which the server writes a block to the storage device #3 (J1), and writes meta data to the storage device #5 (J2). In addition, the server accesses the storage device #5 so as to search the storage device #5 for any piece of meta data (J3).

Related techniques are disclosed, for example, in Japanese Laid-open Patent Publication No. 2010-238038 and Japanese Laid-open Patent Publication No. 11-24981.

However, in the above-described technology by which meta data and a block are written to the different storage devices 40, respectively, the dedicated storage device #5 dedicated to meta data is desired to be provided, so that manufacturing cost may be increased.

In addition, read access for any piece of meta data is concentrated on the dedicated storage device #5 dedicated to meta data, so that overload may also be applied to the dedicated storage device #5 dedicated to meta data, and the read/write performance of meta data is reduced.

### SUMMARY

According to an aspect of the present invention, provided is an information processing system including a plurality of storage devices and an information processing device. Each of the plurality of storage devices is configured to store therein both of block data and meta data. The information processing device includes a first processor. The first processor is configured to write first meta data to a first storage device from among the plurality of storage devices. The first processor is configured to write first block data corresponding to the first meta data to a second storage device from among the plurality of storage devices. The second storage device is different from the first storage device.

The objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating data streaming in a storage system according to an embodiment;

FIG. 2 is a diagram illustrating a configuration of a storage system according to an embodiment;

FIG. 3 is a diagram illustrating an example of a functional configuration of a CPU that is included in a client according to an embodiment;

FIG. 4 is a diagram illustrating an example of a functional configuration of a CPU that is included in a server according to an embodiment;

FIG. 5 is a diagram illustrating a method of generating fixed length meta data in a storage system according to an embodiment;

FIG. 6 is a diagram illustrating undefined length meta data in a storage system according to an embodiment;

FIG. 7 is a diagram illustrating a method of searching for fixed length meta data in a storage system according to an embodiment;

FIG. 8 is a diagram illustrating a method of writing data to a storage device by a server according to an embodiment;

FIG. 9 is a diagram illustrating a method of writing data to a plurality of storage devices by a server according to an embodiment;

FIG. 10A is a diagram illustrating an example of storage location information in a storage system according to an embodiment;

FIG. 10B is a diagram illustrating an example of block management information in a storage system according to an embodiment;

FIG. 11 is a diagram illustrating a method of writing or reading data to or from storage devices by a server according to an embodiment;

FIG. 12 is a flowchart illustrating write processing to storage devices by a server according to an embodiment;

FIG. 13 is a diagram illustrating a search frequency for each of storage devices in a storage system according to an embodiment;

FIG. 14 is a diagram illustrating an effect of a storage system according to an embodiment;

FIG. 15 is a diagram illustrating an effect of a storage system according to an embodiment;

FIG. 16 is a diagram illustrating a method of writing or reading data to or from a storage device in a storage system of a related art; and

FIG. 17 is a diagram illustrating a method of writing or reading data to or from a storage device in a storage system of a related art.

### DESCRIPTION OF EMBODIMENT

An embodiment related to an information processing system and a method for controlling data access to storage devices is described below with reference to drawings. The embodiment described below is merely an example, and is not intended to exclude various modifications and applications of the technology discussed herein, which are not specified in the embodiment. That is, the embodiment may be implemented in various modifications without departing from the spirit thereof.

Each figure is not intended to include only the illustrated components, but may further include other functions and the like.

Hereinafter, a similar symbol is assigned to similar portions in the figures, and redundant descriptions thereof are omitted.

### Embodiment

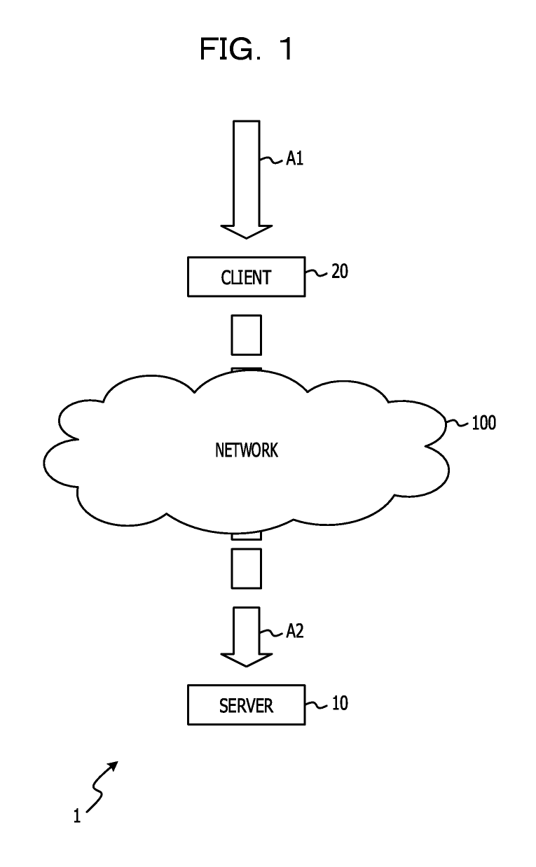

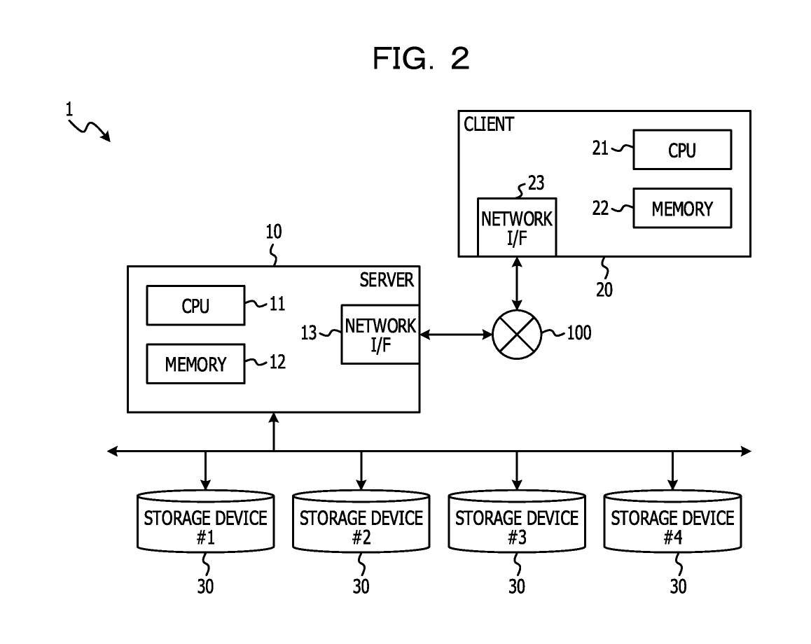

FIG. 1 is a diagram illustrating data streaming in a storage system according to an embodiment. FIG. 2 is a diagram illustrating a configuration of the storage system according to the embodiment.

As illustrated in FIG. 2, a storage system (information processing system) 1 according to the embodiment includes a server (information processing device) 10, a client (terminal device) 20, and a plurality of (four in the example of FIG. 2) storage devices 30. The server 10 is communicably connected to the client 20 through a network 100. The server 10 is also communicably connected to the plurality of storage devices 30.

In a storage system 1 illustrated in FIG. 1, for the sake of simplicity, illustration of the plurality of storage devices 30 is omitted.

The storage system 1 is a system that accumulates streaming data, and is, for example, a packet capturing system.

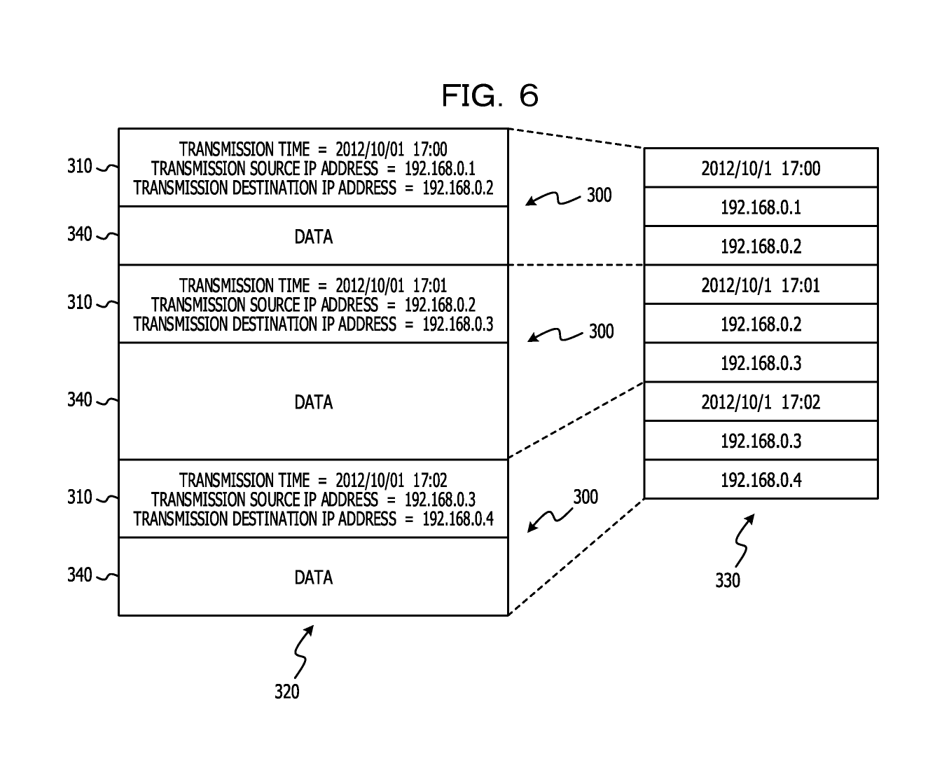

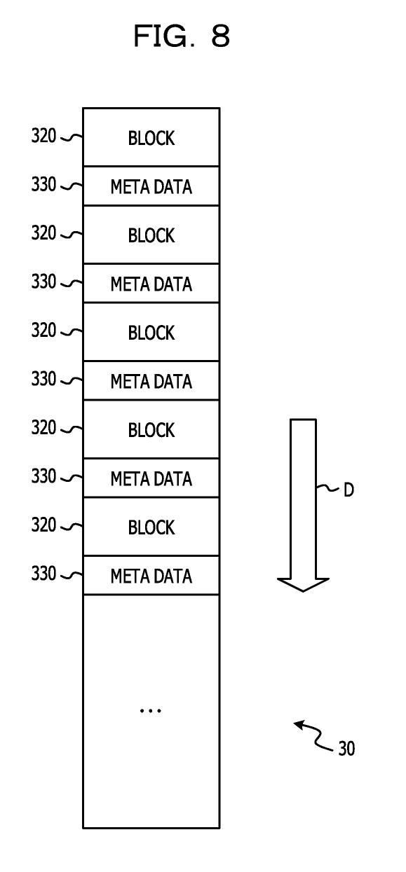

As illustrated in FIG. 1, the client 20 receives streaming data that is transmitted from an external device that is not illustrated (A1), and divides the received streaming data into blocks (block data) 320 each of which has a fixed length or an undefined length (the detail is described later with reference to FIGS. 6 and 8). The client 20 transmits a write request to the server 10 through the network 100, for example, in a unit of the block 320 (A2).

In the example illustrated in FIG. 2, numbers of #1 to #4 are respectively assigned to the four storage devices 30. Hereinafter, when one of the plurality of storage devices 30 is specified, the storage devices are simply referred to as storage devices #1 to #4.

The storage device 30 is a known device that stores data therein so that the data is allowed to be read and written. The storage device 30 includes for example, a hard disk drive (HDD) and a solid state drive (SSD). The storage devices 30 have a similar functional configuration.

The client 20 includes a central processing unit (CPU) 21, a memory 22 and, a network interface (I/F) 23.

The network I/F 23 is an interface device connecting the client 20 to the network 100, and is used to communicate with the server 10 and external devices (not illustrated) through the network 100. The network I/F 23 may be, for example, interface cards compliant with various standards of the network 100, such as a wired local area network (LAN), a wireless LAN, a wireless wide area network (WWAN), and the like.

The memory 22 is a storage device that includes a read-only memory (ROM) and a random access memory (RAM). In the ROM of the memory 22, a program of a basic input/output system (BIOS) and the like are written. A software program on the memory 22 is read and executed by the CPU 21 as appropriate. The RAM of the memory 22 is used as a primary record memory or a working memory.

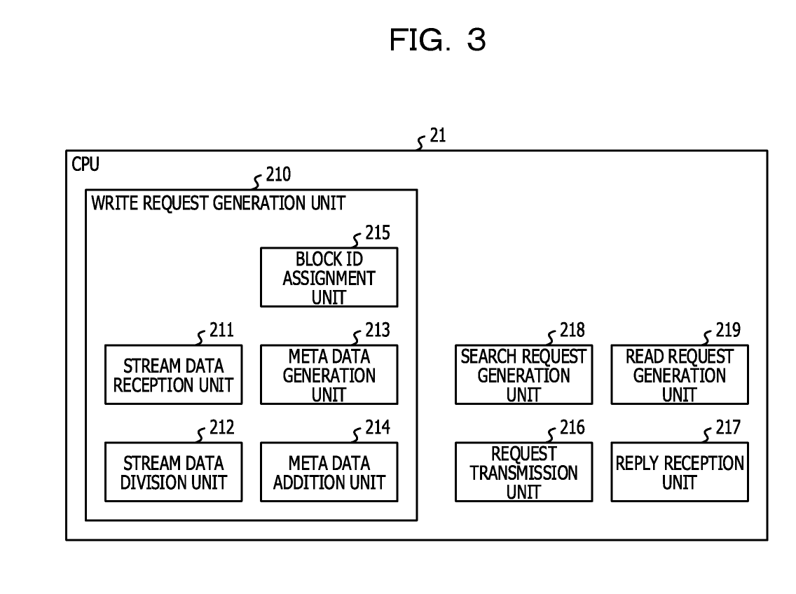

FIG. 3 is a diagram illustrating an example of a functional configuration of the CPU 21 included in the client 20 according to the embodiment.

The CPU 21 is a processing device that performs various pieces of control and calculation and achieves various functions by executing an operating system (OS) and a program stored in the memory 22. As illustrated in FIG. 3, the CPU 21 functions as a write request generation unit 210, a request transmission unit 216, a reply reception unit 217, a search request generation unit 218, and a read request generation unit 219.

For example, programs that are executed to achieve the functions as the write request generation unit 210, the request transmission unit 216, the reply reception unit 217, the search request generation unit 218, and the read request generation unit 219 are recorded to a computer-readable recording medium to be distributed. Examples of the computer-readable recording medium include a flexible disk, a compact disk (CD) such as CD-ROM, CD-R, CD-RW, or the like, a digital versatile disc (DVD) such as DVD-ROM, DVD-RAM, DVD-R, DVD+R, DVD-RW, DVD+RW, HD DVD, or the like, a Blu-ray disk, a magnetic disk, an optical disk, or a magneto optical disk. The computer reads the program from the recording medium through a reading device (not illustrated), transfers the program to an internal recording device or an external recording device, and stores the program in the internal recording device or the external recording device to execute the program. The program may be recorded to a storage device (recording medium) such as a magnetic disk, an optical disk, or a magneto optical disk, to be distributed to the computer from the storage device through a communication path.

When the functions as the write request generation unit 210, the request transmission unit 216, the reply reception unit 217, the search request generation unit 218, and the read request generation unit 219 are achieved, the program stored in the internal recording device (memory 22 in the embodiment) is executed by a microprocessor (CPU 21 in the embodiment) of the computer. At that time, the program recorded to the recording medium may be read and executed by the computer.

The write request generation unit 210 functions as a streaming data reception unit 211, a streaming data division unit 212, a meta data generation unit 213, a meta data addition unit 214, and a block ID assignment unit 215.

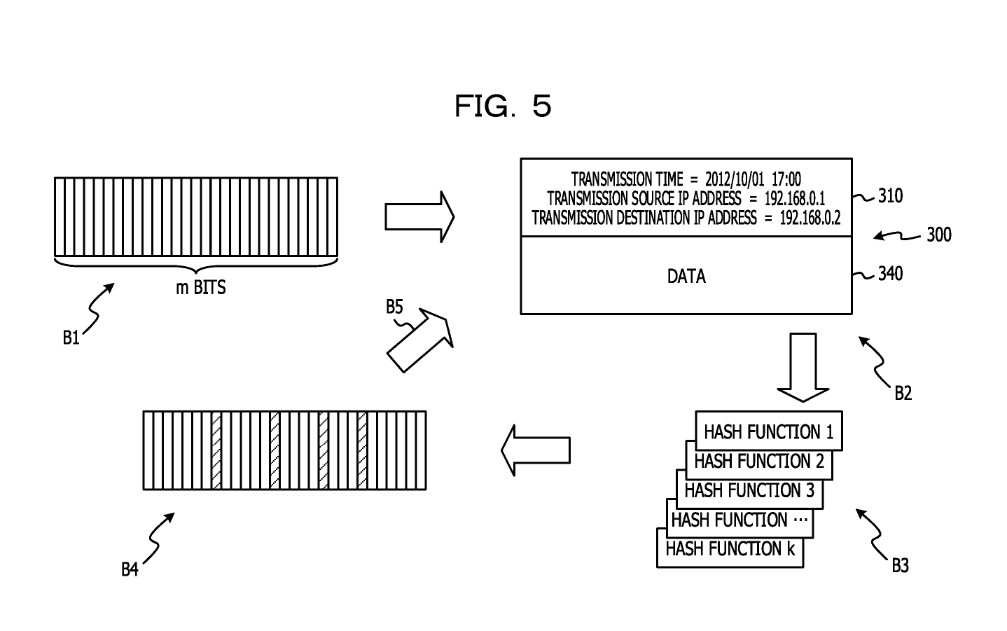

The streaming data reception unit 211 receives streaming data transmitted from an external device (not illustrated). The streaming data includes a plurality of pieces of event data 300 (the detail is described later with reference to FIGS. 5 and 6). For example, in the case of the packet capturing system, the event data 300 corresponds to a packet. The size of the event data 300 may be a fixed length, or an undefined length.

The streaming data division unit 212 divides the streaming data into blocks 320 each of which has a fixed length or undefined length (the detail is described later). The number of pieces of event data 300 included in the divided blocks 320 is undefined in general.

The meta data generation unit 213 generates meta data 330 corresponding to the event data 300.

FIG. 5 is a diagram illustrating a method of generating fixed length meta data in the storage system according to the embodiment.

As the fixed length meta data, for example, a bloom filter is used (B1).

The bloom filter is created for each attribute, and has a bit array of m bits. In an empty bloom filter, “0” is set to all of the bits.

The event data 300 includes attribute information (header) 310 and data (payload) 340. The attribute information 310 includes a transmission time, a transmission source Internet Protocol (IP) address, and a transmission destination IP address. In the example illustrated in FIG. 5, the streaming data reception unit 211 receives the event data 300 in which the transmission time is “2012/10/01 17:00”, and the transmission source IP address is “192.168.0.1”, and the transmission destination IP address is “192.168.0.2” (B2).

The meta data generation unit 213 inputs the transmission source IP address “192.168.0.1” to k hash functions, and obtains k bit positions as outputs (B3).

The meta data generation unit 213 sets “1” to each of the k bit positions in the bloom filter (B4).

The processing of B2 to B4 is repeated until the total size of the received pieces of event data 300 reaches a threshold value (size of the block 320) (B5).

FIG. 6 is a diagram illustrating undefined length meta data in the storage system according to the embodiment.

The meta data generation unit 213 may generate the meta data 330 having an undefined length.

In the example illustrated in FIG. 6, the event data 300 includes a header 310 and data 340, and the meta data 330 corresponds to each of the pieces of the event data 300. A plurality (three in the example illustrated in FIG. 6) of pieces of event data 300 constitutes a block 320.

The number of pieces of event data 300 included in the block 320 is undefined in general, so that the size of the meta data 330 added to the block 320 is also undefined. However, it is assumed that an upper limit of the size of the meta data 330 added to the block 320 is determined.

The above-described method of generating the meta data 330 by the meta data generation unit 213 is merely an example, and the meta data generation unit 213 may be implemented with various modifications of switching of the fixed length meta data and the undefined length meta data, and the like.

The meta data addition unit 214 adds the meta data 330 to the blocks 320 divided by the streaming data division unit 212.

When the meta data 330 added to the block 320 has a fixed length, the streaming data division unit 212 performs division into the blocks 320 when the total size of the received pieces of event data 300 reaches a specific value (block size).

When the meta data 330 added to the block 320 has an undefined length, upper limits (hereinafter referred to as a maximum block size and a maximum meta data size, respectively) of the sizes of the block 320 and the meta data 330 are determined. When the total size of the received pieces of event data 300 reaches the maximum block size before the size of the meta data 330 that corresponds to all of the received pieces of event data 300 reaches the maximum meta data size, the size of the block 320 corresponds to the maximum block size. On the other hand, when the meta data 330 corresponding to all of the received pieces of event data 300 reaches the maximum meta data size before the size of all of the received pieces of event data 300 reaches the maximum block size, the size of the block 320 corresponds to an undefined length.

When the streaming data is divided in the blocks by the streaming data division unit 212, the meta data addition unit 214 adds the meta data 330 corresponding to the event data 300 included in the divided blocks 320, to the blocks 320 (the detail is described later). The size of the meta data 330 added to the blocks 320 may correspond to a fixed length, or may correspond to an undefined length.

The block ID assignment unit 215 assigns a unique block ID to the block 320. Hereinafter, for the sake of simplicity, it is assumed that the block ID corresponds to a transmission time of the leading event data 300 of the block 320 (for example, the block ID is “2012/10/01 17:00:15”).

The search request generation unit 218 generates a search request that includes a search target time period and a search condition. In the packet capturing system, the search target time period corresponds to, for example, the blocks 320 accumulated between “17:00” on “2012/10/01” and “18:00” on “2012/10/01”. In addition, the search condition corresponds to, for example, the block 320 that includes a packet transmitted from the IP address “192.168.0.1” to the IP address “192.168.0.2”.

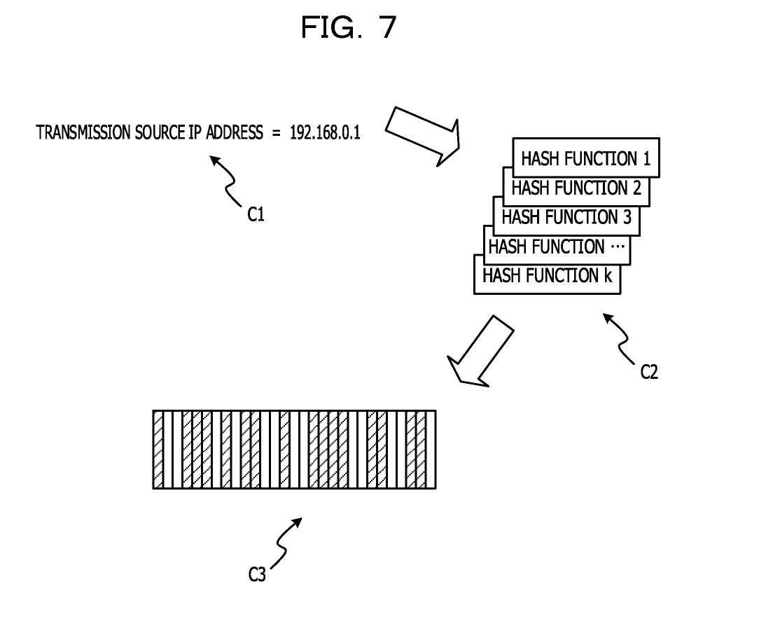

FIG. 7 is a diagram illustrating a method of searching for fixed length meta data in the storage system according to the embodiment.

At the time of searching for the event data 300, the search request execution unit 115 inputs a value of a search target to the k hash functions, and obtains k bit positions as outputs. The search request execution unit 115 checks the bloom filter, and determines that the bloom filter includes the search target when all of the k bit positions correspond to “1”.

In the example illustrated in FIG. 7, the search request execution unit 115 checks whether a bloom filter includes a transmission source IP address “192.168.0.1” (C1).

The search request execution unit 115 inputs the transmission source IP address “192.168.0.1” that is the search target, to the k hash functions, and obtains k bit positions (C2).

The search request execution unit 115 checks all bit positions output by the hash functions in the bloom filter (C3), and determines that the bloom filter includes the value of “192.168.0.1” when all of the bit positions correspond to “1”.

In the fixed length meta data, the size of the bloom filter for each attribute is fixed, so that the size of the meta data added to the block 320 is fixed as “the number of attributes x the size of the bloom filter”.

The read request generation unit 219 generates a read request. Various known technologies may be applied to the method of generating a read request by the read request generation unit 219, so that the description thereof is omitted.

The request transmission unit 216 transmits a write request, the block 320, and the meta data 330, to the server 10. That is, the request transmission unit 216 functions as an output unit outputting a write request that includes the meta data 330 and the block 320. The request transmission unit 216 also transmits a search request and a read request, to the server 10.

The reply reception unit 217 receives a reply from the server 10. For example, the reply reception unit 217 receives results of the write request, the search request, and the read request to the server 10.

As illustrated in FIG. 2, the server 10 includes a CPU (computer) 11, a memory 12, and a network I/F 13.

The network I/F 13 is an interface device that connects the server 10 to the network 100, and allows the server 10 to communicate with the client 20 or an external device (not illustrated) through the network 100. The network I/F 13 may be, for example, interface cards compliant with various standards of the network 100, such as a wired LAN, a wireless LAN, and a WWAN.

The memory 12 is a storage device that includes a ROM and a RAM. In the ROM of the memory 12, a program of a BIOS and the like are written. A software program on the memory 12 is read and executed by the CPU 11 as appropriate. The RAM of the memory 12 is used as a primary record memory or a working memory.

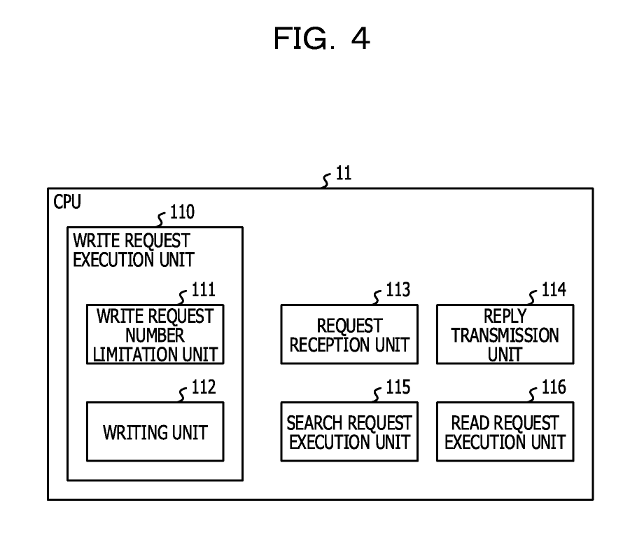

FIG. 4 is a diagram illustrating an example of a functional configuration of the CPU 11 included in the server 10 according to the embodiment.

The CPU 11 is a processing device that performs various pieces of control and calculation, and achieves various functions by executing an OS and a program stored in the memory 12. As illustrated in FIG. 4, the CPU 11 functions as a write request execution unit 110, a request reception unit 113, a reply transmission unit 114, a search request execution unit 115, and a read request execution unit 116.

Programs (control programs) that are executed to achieve the functions as the write request execution unit 110, the request reception unit 113, the reply transmission unit 114, the search request execution unit 115, and the read request execution unit 116 are recorded, for example, to a computer-readable recording medium to be distributed. Examples of the computer-readable recording medium include a flexible disk, a CD such as CD-ROM, CD-R, CD-RW, or the like, the DVD such as DVD-ROM, DVD-RAM, DVD-R, DVD+R, DVD-RW, DVD+RW, HD DVD, or the like, the Blu-ray disk, the magnetic disk, the optical disk, or the magneto optical disk. The computer reads the program from the recording medium through a reading device (not illustrated), transfers the program to the internal recording device or the external recording device, and stores the program in an internal recording device or an external recording device to execute the program. The program may be recorded to a storage device (recording medium) such as a magnetic disk, an optical disk, or a magneto optical disk, to be distributed from the storage device to the computer through a communication path.

When the functions as the write request execution unit 110, the request reception unit 113, the reply transmission unit 114, the search request execution unit 115, and the read request execution unit 116 are achieved, the program stored in the internal recording device (memory 12 in the embodiment) is executed by a microprocessor (CPU 11 in the embodiment) of the computer. At that time, the program recorded to the recording medium may be read and executed by the computer.

The request reception unit 113 functions as a reception unit that receives a write request transmitted (output) from the client 20. In addition, the request reception unit 113 also receives a search request and a read request transmitted (output) from the client 20.

As illustrated in FIG. 4, the write request execution unit 110 functions as a write request number limitation unit 111 and a writing unit 112.

In the embodiment, an upper limit of the number of write requests that are allowed to be executed concurrently is determined. The write request number limitation unit 111 monitors the number of write requests in operation, and discards a write request that has been newly received when the number of write requests in operation exceeds the upper limit. For example, when an execution time of a write request is extended due to the reduction in the write performance of the storage device 30, the number of write requests executed concurrently is increased, and a write request is easily discarded.

FIG. 8 is a diagram illustrating a method of writing data to the storage device 30 by the server 10 according to the embodiment.

The writing unit 112 writes the block 320 to the storage device 30 in order of arrival, and writes the meta data 330 between the blocks 320 in order of arrival (D).

In the example illustrated in FIG. 8, the writing unit 112 assigns an area of a fixed length to the block 320 and the meta data 330 and performs writing to the storage device 30.

Hereinafter, the area of the meta data 330 and the area of the block 320 in the storage device 30 are referred to as a meta data reserved area and a block reserved area, respectively. The size of a meta data reserved area and the size of a block reserved area are respectively referred to as a meta data reserved size S_{M} and a block reserved size S_{B}.

When the size of meta data 330 has a fixed length, the block reserved size S_{B} is the size of a block 320, and the meta data reserved size S_{M} is the size of the meta data 330. On the other hand, the size of meta data 330 has an undefined length, the block reserved size S_{B} is the maximum block size, and the meta data reserved size S_{M} is the maximum meta data size.

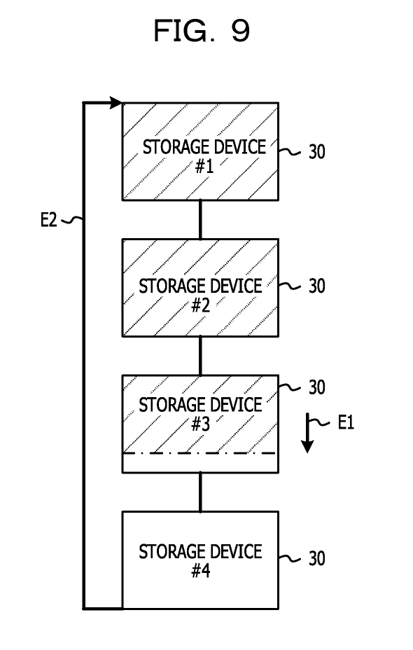

FIG. 9 is a diagram illustrating a method of writing data to a plurality of storage devices 30 by the server 10 according to the embodiment.

In the example illustrated in FIG. 9, the server 10 manages four storage devices 30 (storage devices #1 to #4).

The writing unit 112 writes the block 320 and the meta data 330 to the four storage devices 30. That is, first, the writing unit 112 writes the block 320 and the meta data 330 to the storage device #1, and then writes the block 320 and the meta data 330 to the storage device #2 when the storage device #1 runs out of space to write data. The writing unit 112 writes the block 320 and the meta data 330 to the storage device #3 when the storage device #2 runs out of space to write data (E1). In the example of FIG. 9, a state is illustrated in which the writing has been completed in the storage device #1 and the storage device #2, and the writing has been partially completed in the storage device #3 (see the hatched portions).

The writing unit 112 writes the block 320 and the meta data 330 to all of the storage areas of the storage devices 30 (storage devices #1 to #4 in the example illustrated in FIG. 9) in order of the storage device #1, the storage device #2, the storage device #3, and the storage device #4. After the writing to the storage device #4 is completed, overwriting of data is performed in order from the leading storage device 30 (storage device #1) (E2).

In the embodiment, continuous addresses are assigned to the plurality of storage devices 30. Hereinafter, “address” refers to an address that is counted from the 0 byte of the leading storage device 30 (storage device #1). In other words, storage areas of the plurality of storage devices 30 are regarded as a continuous address space. That is, the storage areas of the storage devices #2, #3, and #4 are continuously coupled to the storage area of the storage device #1. Addresses of the second storage device are set so as to be continuous to addresses of the first storage device.

Hereinafter, in the storage devices #1 to #4 that have the sequence as described above, the storage device 30 in which the writing is performed previously may be referred to as a previous device, and the storage device 30 in which the writing is performed next may be referred to as a next device.

Suppose that the number of the storage devices 30 managed by the server 10 is N_{HDD} and the capacity (the size of an available data storage area) of a single storage device 30 is C_{HDD}, then the range of all addresses corresponds to 0 or more and less than N_{HDD}×C_{HDD}.

Each of the storage devices 30 may store n blocks 320 and n pieces of meta data 330 at maximum (n is a natural number).

The writing unit 112 writes the block 320 and the corresponding meta data 330 such that a distance from the storage position of the block 320 to the storage position of the corresponding meta data 330 is n or more so as to write the block 320 and the corresponding meta data 330 to different storage devices 30.

The writing unit 112 functions as a first writing unit that writes the meta data 330 to a first storage device from among the plurality of storage devices 30. In addition, the writing unit 112 also functions as a second writing unit that writes the block 320 corresponding to the meta data 330 to a second storage device that is different from the first storage device, from among the plurality of storage devices 30.

The writing unit 112 stores the block 320 and the corresponding meta data 330 in the different storage devices 30, respectively. For example, the writing unit 112 writes the meta data 330 to a previous (in the upper direction in FIG. 9) storage device 30 of the storage device 30 to which the block 320 is written. That is, the writing unit 112 stores the meta data 330 corresponding to the block 320 stored in the j-th storage device 30, in the (j−1)-th storage device 30 (j=2, 3, . . . , and N_{HDD}). When “j=1” is satisfied, the writing unit 112 stores the meta data 330 corresponding to the block 320, in the N_{HDD}-th storage device 30.

Hereinafter, in the address space that is obtained by integrating the storage devices #1 to #4, the meta data 330 stored in the i_{M}-th (i_{M} is an integer of 0 or more) meta data reserved area from the head of the address space is referred to as the meta data 330 of the storage position i_{M}. The block 320 that is stored in the i_{B}-th (i_{B} is an integer of 0 or more) block reserved area from the head of the address space is referred to as the block 320 of the storage position i_{B}.

A relationship between the storage position i_{M} of the meta data 330 and the storage position i_{B} of the corresponding block 320 is set as i_{B}=i_{M}+n.

An address A_{B} at which the writing unit 112 writes the block 320 is represented by the following formula.

A_{B}=i_{B}×(S_{B}+S_{M})

S_{B} and S_{M} respectively represent a block reserved size and a meta data reserved size.

An address A_{M} at which the writing unit 112 writes the meta data 330 is represented by the following formula.

A_{M}=I_{M}×(S_{B}+S_{M})+S_{B}

The capacity of a single storage device 30 (size of an available data storage area) C_{HDD} is represented by the following formula.

C_{HDD}=n×(S_{B}+S_{M})

That is, the writing unit 112 (second writing unit) writes the block 320 at the address A_{B} separated from the address A_{M} of the meta data 330 written by the writing unit 112 (first writing unit) by an address range n×(S_{B}+S_{M}) of the first storage device (for example, storage device #1) or more. As a result, the writing unit 112 (second writing unit) writes the block 320 in the second storage device (for example, the storage device #2) that is different from the first storage device.

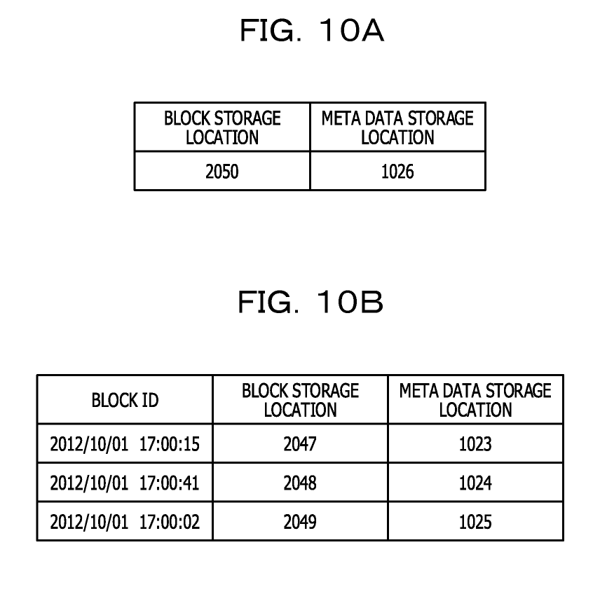

FIG. 10A is a diagram illustrating an example of storage location information in the storage system 1 according to the embodiment. FIG. 10B is a diagram illustrating an example of block management information in the storage system 1 according to the embodiment.

The memory 12 or a storage device (not illustrated) included in the server 10 stores storage location information as illustrated in FIG. 10A and block management information as illustrated in FIG. 10B.

The block management information is management information that indicates storage positions of the block 320 and the meta data 330 that are successfully written to the storage device 30 by the writing unit 112. For example, the block management information includes a block ID, a block storage position, and a meta data storage position. For example, the writing unit 112 updates the block management information each time the block 320 and the meta data 330 are written to the storage devices 30.

The storage location information is information that indicates storage positions of the block 320 and the meta data 330 to be received by the server 10 and to be written to the storage devices 30, and indicates storage positions of the block 320 and the meta data 330 corresponding to the block 320. For example, the storage location information includes a block storage position and a meta data storage position that is an address separated from an address of the block storage position by a predetermined distance. For example, the writing unit 112 creates the storage location information, based on block management information for the block 320 and the meta data 330 written last.

In the storage location information and the block management information, the writing unit 112 sets a block storage position and a meta data storage position such that the block storage position is separated from the meta data storage position by the maximum number n, which is the number of the blocks 320 and the pieces of meta data 330 to be stored in each of the storage devices 30, or more. In the example illustrated in FIGS. 10A and 10B, the writing unit 112 sets a block storage position and a meta data storage position such that the block storage position is separated from the meta data storage position by “1024”.

The search request execution unit 115 reads, from the storage device 30, corresponding meta data 330 for all of blocks 320 in a search target time period specified in a search request. The search request execution unit 115 searches block management information for block IDs, based on the search target time period, and identifies block IDs of the blocks 320, which satisfy the condition. The search request execution unit 115 identifies pieces of meta data 330 that correspond to the search target blocks 320, based on the block management information illustrated in FIG. 10B. The search request execution unit 115 determines whether or not each of the corresponding blocks 320 includes a packet that satisfies the condition, by checking the identified meta data 330.

The read request execution unit 116 reads a block 320 specified by a read request, from the storage device 30.

The reply transmission unit 114 transmits a reply to the client 20. Specifically, the reply transmission unit 114 transmits an execution result of a write request, a search request, and a read request, to the client 20. For example, the reply transmission unit 114 transmits a write result as a reply for a write request, and transmits a list of block IDs of blocks each of which includes a packet that satisfies the search condition, as a reply for a search request. The reply transmission unit 114 also transmits read data of a block 320, as a reply for a read request. When a write request is discarded by the write request number limitation unit 111 while the write request is being executed, the reply transmission unit 114 transmits notification indicating that discard of the write request has occurred.

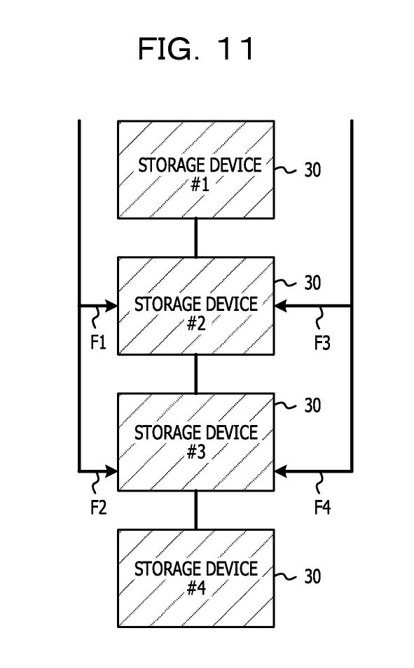

FIG. 11 is a diagram illustrating a method of writing or reading data to or from the storage devices 30 by the server 10 according to the embodiment.

In the example illustrated in FIG. 11, the writing unit 112 writes meta data 330 to the storage device #2 (F1), and writes a block 320 corresponding to the meta data 330, to the storage device #3 (F2). Thus, the writing unit 112 writes the meta data 330 and the block 320 corresponding to the meta data 330 in the different storage devices 30, respectively.

The search request execution unit 115 reads, from the storage device #2, the meta data 330 corresponding to the block 320 stored in the storage device #3 (F3). The search request execution unit 115 reads, from the storage device #3, the meta data 330 corresponding to the block 320 stored in the storage device #4 (F4).

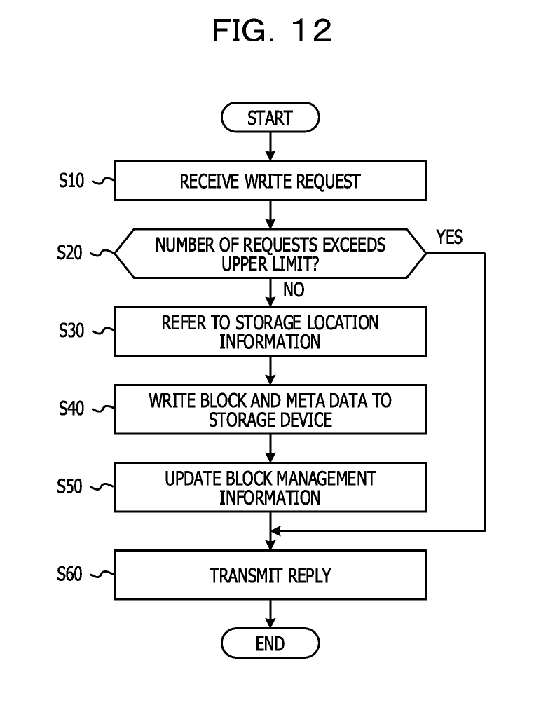

The write processing to the storage devices 30 by the server 10 according to the embodiment is described with reference to the flowchart (S10 to S60) illustrated in FIG. 12.

The request reception unit 113 receives a write request from the client 20 (S10).

The write request number limitation unit 111 determines whether or not the number of requests exceeds an upper limit (S20).

When the write request number limitation unit 111 determines that the number of requests exceeds the upper limit (Yes in S20), the flow proceeds to S60.

When the write request number limitation unit 111 determines that the number of requests does not exceed the upper limit (No in S20), the writing unit 112 refers to the storage location information illustrated in FIG. 10A (S30).

The writing unit 112 writes the block 320 and the meta data 330 to the storage devices 30, based on the storage location information (S40). That is, the writing unit 112 performs the writing such that the storage position of the block 320 is separated from the storage position of the corresponding meta data 330 by the maximum number n, which is the number of the blocks 320 and the pieces of meta data 330 to be stored in each of the storage devices 30, or more. As a result, the writing unit 112 writes the block 320 and the corresponding meta data 330 in the different storage devices 30, respectively.

That is, the writing unit 112 (first writing unit) writes the meta data 330 to a first storage device (for example, the storage device #1) from among a plurality of storage devices 30 to which the meta data 330 and the block 320 are to be written. In addition, the writing unit 112 (second writing unit) writes the block 320 corresponding to the meta data 330 to a second storage device (for example, the storage device #2) different from the first storage device, from among the plurality of storage devices 30. Continuous addresses are assigned to the plurality of storage devices 30. The second writing unit writes the block 320 to the second storage device by writing the block 320 to an address separated from an address of the meta data 330 written by the first writing unit by an address range of the first storage device or more.

The writing unit 112 updates the block management information illustrated in FIG. 1013 (S50).

The reply transmission unit 114 transmits an execution result of the write request, to the client 20 as a reply (S60).

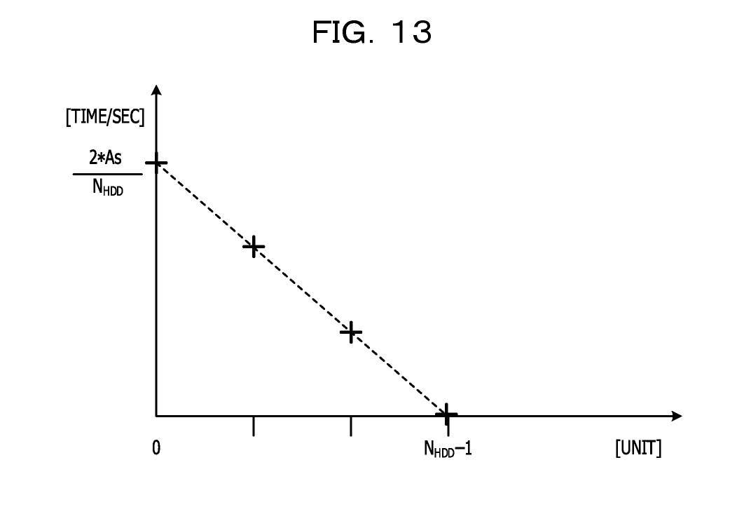

An effect that is obtained by the storage system 1 according to the embodiment is described below with reference to FIGS. 13 to 15.

FIG. 13 is a diagram illustrating search frequency for each of the storage devices 30 in the storage system 1 according to the embodiment.

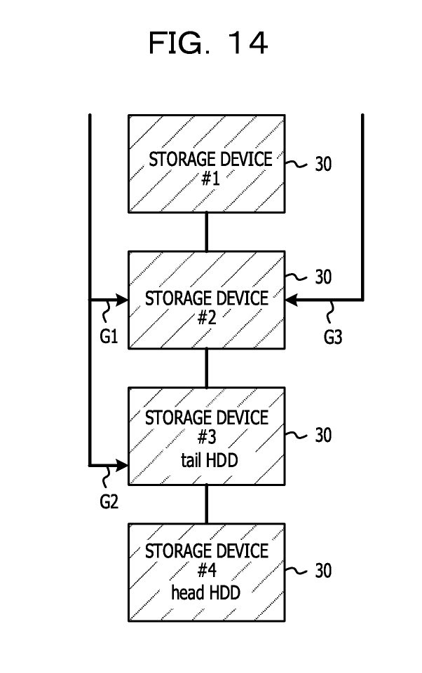

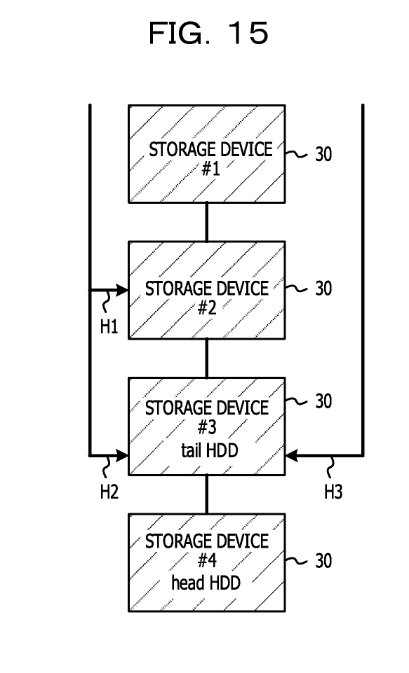

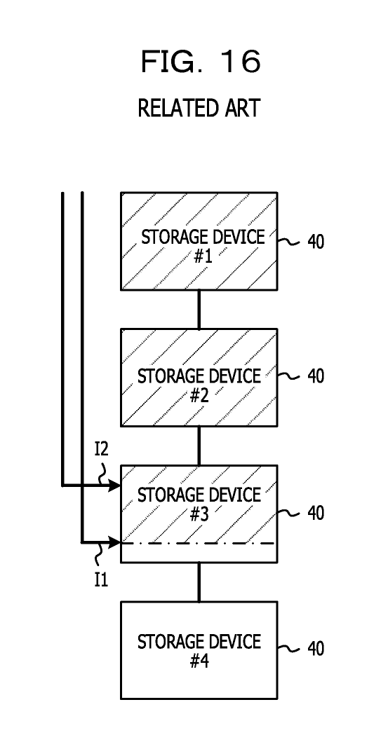

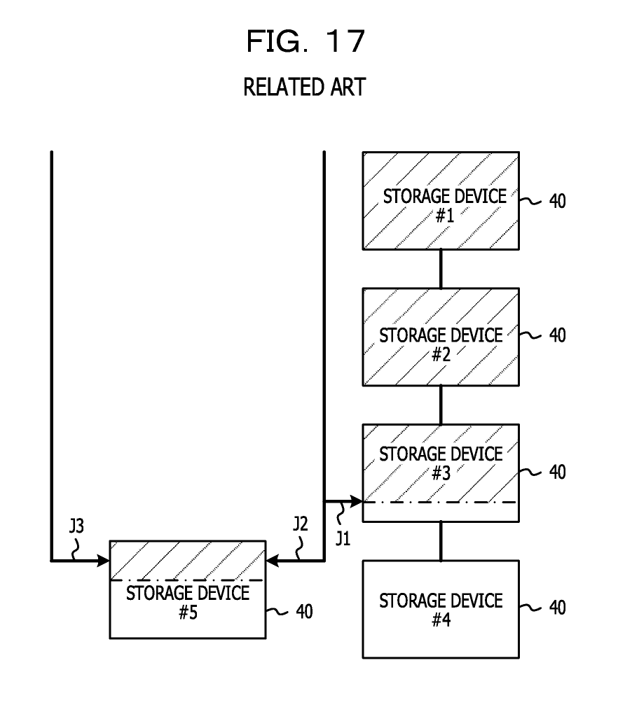

Hereinafter, the storage device 30 to which the block 320 is being written is referred to as a tail HDD, and the next storage device 30 to the tail HDD is referred to as a head HDD. That is, the most recent block 320 is stored in the tail HDD, and the block 320 becomes older as moving to the past from the tail HDD (in an upward direction in FIG. 14 and FIG. 15), and the head HDD stores the oldest block 320.

Suppose that a frequency of a write request is represented as A_{w} (time/second), a total frequency of a search request is represented as Aₛ (time/second), and a distance between the tail HDD and the storage device 30 in which a search target block 320 is stored is represented as i (=0, 1, . . . , and N_{HDD}−1) (unit).

Then, a search frequency for the search target block 320 is represented by the following mathematical expression.

$$\frac{2 \times {A}_{S} \times ( {N}_{HDD} - 1 - i )}{{N}_{HDD} \times ( {N}_{HDD} - 1 )} ( time \text{/} second )$$

That is, a search frequency for a block 320 stored in the tail HDD is represented by the following mathematical expression.

$$\frac{2 \times {A}_{S}}{{N}_{HDD}} ( time \text{/} second )$$

A search frequency for a block 320 stored in the head HDD is 0 (time/second).

As described above, the search frequency for the tail HDD that is the storage device 30 to which the block 320 is being written is high, and the search frequency becomes lower as the storage device is separated from the tail HDD, and the search frequency for the head HDD is lowest. That is, in the streaming data, a search frequency for a new block 320 is high, and a search frequency for an old block 320 is low.

FIGS. 14 and 15 are diagrams illustrating effects of the storage system 1 according to the embodiment.

In the example illustrated in FIG. 14, the writing unit 112 writes meta data 330 to the storage device #2 (G1), and writes a block 320 to the storage device #3 (G2). The storage device #3 is a tail HDD, and the storage device #4 is a head HDD.

The search request execution unit 115 reads, from the storage device #2, meta data 330 corresponding to a block 320 stored in the storage device #3 (G3) while writing is performed by the writing unit 112.

That is, in the example illustrated in FIG. 14, there is no conflict between writing of a block 320 by the writing unit 112 (G2) and reading of meta data 330 by the search request execution unit 115 (G3).

On the other hand, there is a conflict between writing of meta data 330 by the writing unit 112 (G1) and reading of meta data 330 by the search request execution unit 115 (G3). However, there is a surplus in the write performance of meta data 330, so that an impact on the write performance by the performance degradation due to the conflict is limited.

In the example illustrated in FIG. 15, the writing unit 112 writes meta data 330 to the storage device #2 (H1), and writes a block 320 to the storage device #3 (H2). The storage device #3 is a tail HDD, and the storage device #4 is a head HDD.

The search request execution unit 115 reads, from the storage device #3, meta data 330 corresponding to a block 320 stored in the storage device #4 (H3) while writing is performed by the writing unit 112.

That is, in the example illustrated in FIG. 15, there is a conflict between writing of the block 320 by the writing unit 112 (H2) and reading of the meta data 330 by the search request execution unit 115 (H3). However, the search target block 320 in H3 is stored in the head HDD, and is one of the oldest block in the blocks 320 stored in the storage system 1. Therefore, the number of read requests and the number of search requests for the search target block 320 in H3 are significantly small (0 in the above-described example in FIG. 13), so that an impact on write performance of the block 320 in H2 is limited.

A meta data access load in a related art and a meta data access load in the embodiment are compared with each other below.

Here, the meta data access load is a total of a write frequency and a search frequency of the meta data 330 in the storage device 30 to which the meta data 330 is written.

Suppose that probability of occurrence of a conflict between a write request and a search request for a block 320 in a storage device 30 to which the block 320 is written is 0 in both of the related art and the embodiment.

A meta data access load in the related art is A₂+Aₛ.

On the other hand, a meta data access load in the embodiment is represented by the following mathematical expression.

$${A}_{W} + \frac{2 \times {A}_{S}}{{N}_{HDD}}$$

That is, when N_{HDD}>2 (unit) is satisfied, the meta data access load in the embodiment is smaller than the meta data access load in the related art.

In the embodiment, a first writing unit writes meta data 330 to a first storage device from among a plurality of storage devices 30, and a second writing unit writes a block 320 corresponding to the meta data 330 to a second storage device different from the first storage device from among the plurality of storage devices 30. The second writing unit writes the block 320 to the second storage device by perform the writing at an address separated from an address of the meta data 330 written by the first writing unit by an address range of the first storage device or more. As described above, in the embodiment, the block 320 and the corresponding meta data 330 may be written into different storage devices 30, respectively, and a load due to access to the storage device 30 may be reduced. In addition, a storage device 30 dedicated to meta data 330 is not desired to be provided, so that manufacturing cost of the storage system 1 may be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system, comprising:
a plurality of storage devices each configured to store therein both of block data and meta data; and
an information processing device including:
a first processor configured to
write first meta data to a first storage device from among the plurality of storage devices, and
write first block data corresponding to the first meta data to a second storage device from among the plurality of storage devices, the second storage device being different from the first storage device.

2. The information processing system according to claim 1, wherein
continuous addresses are assigned to the plurality of storage devices, and
the first processor is configured to
write the first block data at a first address separated from a second address by an address range of the first storage device or more to write the first block data to the second storage device, the first meta data being written at the second address.

3. The information processing system according to claim 2, wherein
addresses assigned to the second storage device are set to be continuous to addresses assigned to the first storage device.

4. The information processing system according to claim 1, further comprising:
a terminal device including:
a second processor configured to
transmit a write request including the first meta data and the first block data to the information processing device.

5. A computer-readable recording medium having stored therein a program for causing a computer to execute a process, the process comprising:
writing first meta data to a first storage device from among a plurality of storage devices each configured to store therein both of block data and meta data; and
writing first block data corresponding to the first meta data to a second storage device from among the plurality of storage devices, the second storage device being different from the first storage device.

6. The computer-readable recording medium according to claim 5, wherein
continuous addresses are assigned to the plurality of storage devices, and
the computer writes the first block data at a first address separated from a second address by an address range of the first storage device or more to write the first block data to the second storage device, the first meta data being written at the second address.

7. The computer-readable recording medium according to claim 6, wherein
addresses assigned to the second storage device are set to be continuous to addresses assigned to the first storage device.

8. A method for controlling data access to storage devices, the method comprising:
writing, by a computer, first meta data to a first storage device from among a plurality of storage devices each configured to store therein both of block data and meta data; and
writing first block data corresponding to the first meta data to a second storage device from among the plurality of storage devices, the second storage device being different from the first storage device.

9. The method according to claim 8, wherein
continuous addresses are assigned to the plurality of storage devices, and
the computer writes the first block data at a first address separated from a second address by an address range of the first storage device or more to write the first block data to the second storage device, the first meta data being written at the second address.

10. The method according to claim 9, wherein
addresses assigned to the second storage device are set to be continuous to addresses assigned to the first storage device.
